(19) United States
(12) Patent Application Publication
(10) Pub. No.: US 2011/0022990 A1
(43) Pub. Date: Jan. 27, 2011

(54) METHOD FOR OPERATION TO A MULTI-TOUCH ENVIRONMENT SCREEN BY USING A TOUCHPAD

(75) Inventors: DENG-JING WU, TAINAN COUNTY (TW); HSUEH-WEI YANG, HSINCHU COUNTY (TW); YU-JEN TSAI, HSINCHU CITY (TW); HSIAO-HUA TSAI, HSINCHU COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: ELAN MICROELECTRONICS CORPORATION, HSINCHU 300 (TW)

(21) Appl. No.: 12/839,613

(22) Filed: Jul. 20, 2010

Related U.S. Application Data
(60) Provisional application No. 61/227,505, filed on Jul. 22, 2009.

(51) Int. Cl. G06F 3/048

(52) U.S. Cl. 715/856

(57) ABSTRACT

A method for operation to a multi-touch environment screen by using a touchpad defines a movable control window on the screen, calculates an inter-window coordinate set of the object mapped from the touchpad to the control window according to an absolute coordinate set of the object on the touchpad and a resolution ratio between the touchpad and the control window when the touchpad is detected being touched, defines a cursor on the screen representative of the object according to the inter-window coordinate set, and changes a coordinate set of the cursor on the screen representative of the object according to a number of the object on the touchpad and movement thereof. This method allows a user to intuitively operate the screen by using the touchpad.

### CROSS REFERENCE TO RELATED APPLICATIONS

This application claims the benefit of U.S. Provisional Application No. 61/227,505, filed on Jul. 22, 2009.

### FIELD OF THE INVENTION

The present invention is related generally to a touchpad and, more particularly, to a method for operation to a multi-touch environment screen by using a touchpad.

### BACKGROUND OF THE INVENTION

The developing touch technology has realized, in addition to the conventional small-size touch screens for portable devices, the operating environments (operating systems) supporting multi-touch screens, such as Windows 7 from Microsoft and iPhone OS from Apple, which allow large-size touch screens to be used for stationary devices and thereby allow users' intuitive operation through the touch screens. However, there are shortcomings related to large-size touch screens, such as the high costs of the hardware and the operation requests users to stay before the screens. As to touch devices other than touch screens, the operation by users' fingers is not conducted directly on their screens, so contact of the fingers to the touch devices is unable to directly control cursor displayed on the screens. Due to the resolution difference between a touch device and a screen, a coordinate set of an object on the touch device can not be directly reflected on the screen.

### SUMMARY OF THE INVENTION

An object of the present invention is to provide a method for operation to a multi-touch environment screen by using a touchpad.

Another object of the present invention is to provide a method to allow users' intuitive operation to a screen by using a touchpad.

According to the present invention, a method for operation to a multi-touch environment screen by using a touchpad defines a movable control window on the screen, computes an inter-window coordinate set of the object mapped from the touchpad to the control window according to an absolute coordinate set of the object on the touchpad and a resolution ratio between the touchpad and the control window when detecting an object touch on the touchpad, defines a cursor representative of the object on the screen according to the inter-window coordinate set, and according to a number and movement of the object on the touchpad, changes a coordinate set of the cursor representative of the object on the screen or the inter-window coordinate set of the cursor representative of the object in the control window.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a flowchart of a method according to the present invention;

FIG. 2 is a schematic drawing showing computation of an inter-window coordinate set of an object according to a resolution ratio between a touchpad and a control window;

FIG. 3 is a schematic drawing illustrating change of coordinate sets of a cursor and the control window on a screen according to a relative movement coordinate of a single object on a touchpad; and

FIG. 4 is a schematic drawing illustrating change of an inter-window coordinate set of a cursor in a control window according to change of absolute coordinate sets of multiple objects on a touchpad.

### DETAILED DESCRIPTION OF THE INVENTION

The present invention allows using a touchpad to support a multi-touch environment screen, instead of letting a user to directly operate on the screen, yet allows the user to intuitively operate the screen, as normal operation performed on a multi-touch environment screen. The touchpad may be one installed on a notebook computer or a peripheral for a personal computer. When incorporating wireless transmission technology, the touchpad frees its user from being tied up before a screen. When a user operates the touchpad, the screen displays a cursor representative of a finger of the user or other objects placed on the touchpad, and the touchpad sends information about the operation to a host in the format supported by the host. Alternatively, the touchpad sends information about the operation to a host in the format supported by the host without displaying a cursor representative of the object on the screen. The touchpad is able to send the same information to the host as normal touchpads, such as absolute coordinate sets of objects on the touchpad, relative coordinate sets, movement directions, movement distance, movement velocity, touched area and pressure. Since there are problems related to multi-finger operation of the touch device such as interlaced cursors or cursors without intuitive correspondence, the present invention provides a method by which a movable control window is defined on a screen, and an object on a touchpad is mapped into the control window. Preferably, an absolute coordinate set of the object on the touchpad and a resolution ratio between the touchpad and the control window are considered in computation of an inter-window coordinate set of the object mapped from the touchpad to the control window, and then a cursor representative of the object is defined according to the inter-window coordinate set, so that the operation performed on the touchpad is converted into an operation to the screen. Thereby, a user is allowed to intuitively operate the screen by using the touchpad, and the operation is as convenient as direct operation made to the screen.

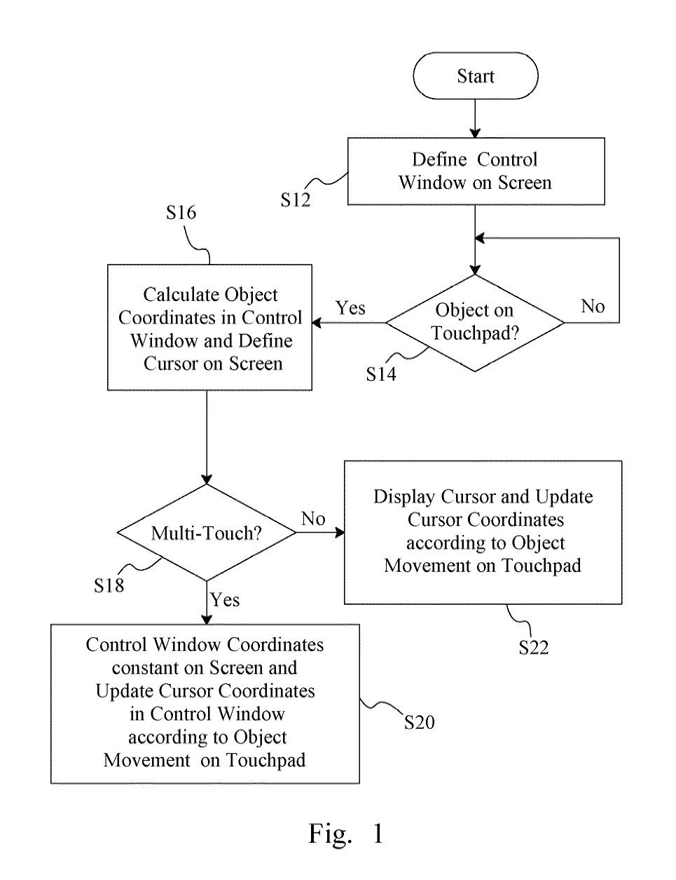

FIG. 1 is a flowchart of a method according to the present invention. Step S12 defines a movable control window on a screen, including a coordinate set of the control window on the screen, while the control window may be displayed on the screen or not. The control window can be regarded as a mapping of the touchpad on the screen, and act as a basis for determination during system operation. Step S14 detects any object touch on the touchpad. If the touchpad is touched, step S16 is performed to calculate an inter-window coordinate set of the object in the control window according to an absolute coordinate set of the object on the touchpad and the resolution ratio between the touchpad and the control window, and define a cursor representative of the object according to the inter-window coordinate set. The cursor representative of the object may be displayed on the screen or not. If there has been any cursor in the control window, the cursor closest to the inter-window coordinate set may be defined as the cursor representative of the object. Preferably, the inter-window coordinate set is further recalculated. Preferably, the coordinate set of the control window is adjusted by using the coordinate set of the cursor representative of the object on the screen as a basis. If there is no cursor in the control window, the cursor representative of the object may be positioned at the site represented by the inter-window coordinate set. Step S18 identifies whether or not there is multi-touch application on the touchpad. If yes, the process goes to step S20 to fix the control window on the screen, or to fix the coordinate set of the control window on the screen, and, according to the relative movement coordinate set of the object on the touchpad, to change the inter-window coordinate set of the cursor representative of the object in the control window, or to change the position of the cursor representative of the object in the control window. Preferably, the screen does not display the cursor representative of the object. If it is identified a single touch in step S18, step S22 is performed to display the cursor representative of the object on the screen, and, according to the relative movement coordinate set of the object on the touchpad, to change the coordinate set of the cursor representative of the object on the screen, which moves the position of the cursor representative of the object on the screen. Preferably, the control window moves along with the cursor representative of the object so that the cursor representative of the object keeps staying in the control window.

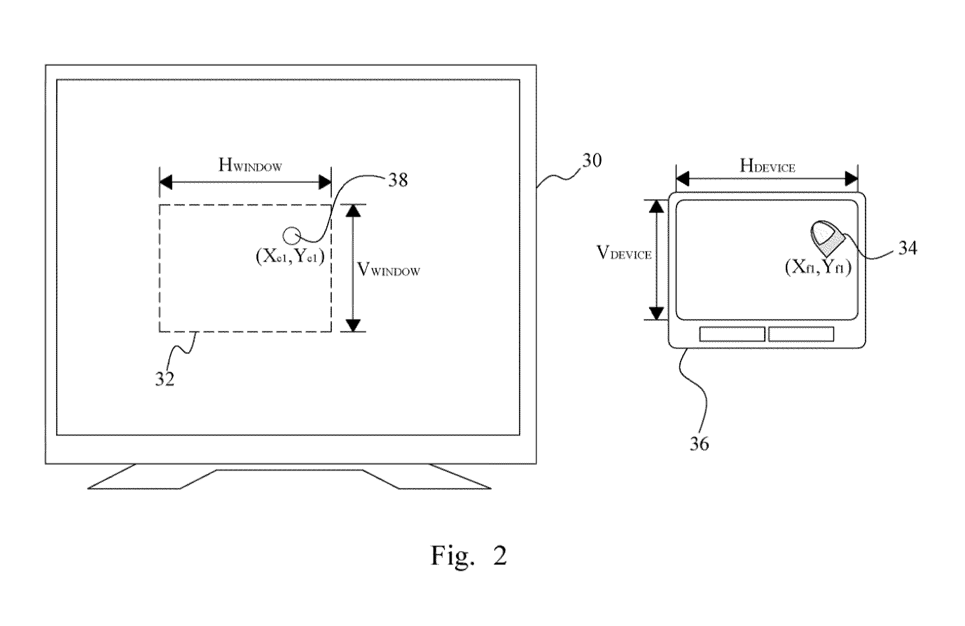

FIG. 2 illustrates step S16 shown in FIG. 1. The resolution of the control window 32 defined on the screen 30 may be customized by the user, with the maximum equal to the resolution of the screen 30. In FIG. 2, the control window 32 is depicted by dotted lines to express that it is positioned at the indicated site, while it is not necessary that the screen 30 displays the control window 32. Displaying the control window 32 on the screen 30 informs the user of the present location of the control window 32. Nevertheless, since the location of the control window 32 is not necessary for the user to perform operation, the control window 32 may not be displayed or may be displayed in a blinking way, or may be briefly shown after defined and then disappear. Since the control window 32 can be regarded as the mapping of the touchpad 36 on the screen 30, it is possible to calculate the inter-window coordinate set of the object 34 mapped from the touchpad 36 to the control window 32 according to the absolute coordinate set (X_{f1},Y_{f1}) of the object 34 on the touchpad 36 and the resolution ratio

$$\frac{{H}_{WINDOW}}{{H}_{DEVICE}}$$

between the touchpad 36 and the control window 32 as

$${X}_{c 1} = \frac{{H}_{WINDOW}}{{H}_{DEVICE}} \times {X}_{f 1} , {Y}_{c 1} = \frac{{V}_{WINDOW}}{{V}_{DEVICE}} \times {Y}_{f 1} . \qquad [ Eq \text{-} 1 ]$$

According to the inter-window coordinate set (X_{c1},Y_{c1}), the cursor 38 representative of the object 34 in the control window 32 is defined. In one embodiment, the cursor 38 representative of the object 34 is located on the site represented by the inter-window coordinate set (X_{c1},Y_{c1}), and the cursor 38 is displayed on the screen 30. In another embodiment, the cursor 38 initially existing in the control window 32 is defined as the cursor representative of the object 34 and the inter-window coordinate set (X_{c1},Y_{c1}) of the cursor 38 in the control window 32 is updated by using the coordinate set of the cursor 38 on the screen 30. Preferably, the coordinate set of the cursor 38 on the screen 30 is further used to adjust the coordinate set of the control window 32 on the screen 30.

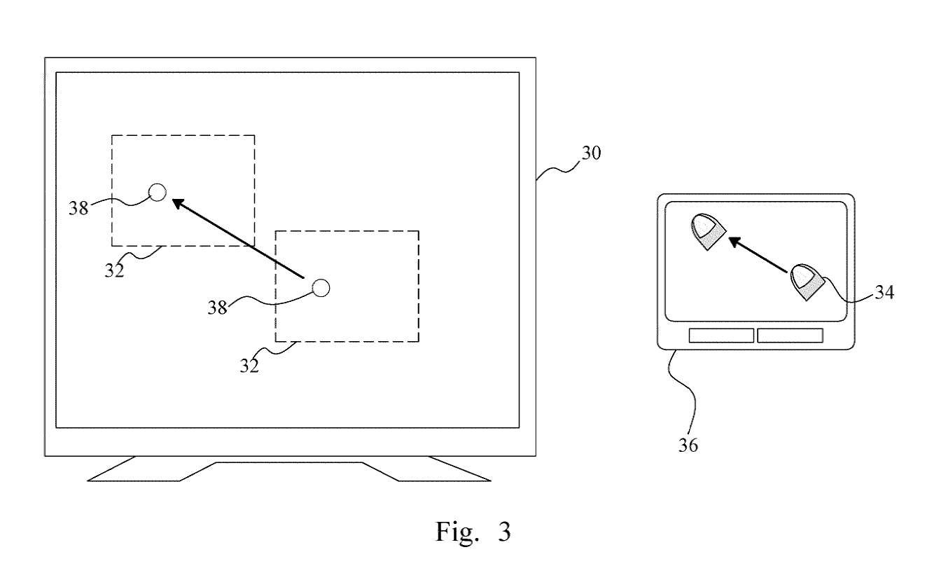

FIG. 3 illustrates step S22 shown in FIG. 1. As can be seen, there is a single object 34 on the touchpad 36. When the object 34 moves on the touchpad 36, the coordinate set of the cursor 38 on the screen 30 is changed according to the relative movement coordinate set of the object 34 on the touchpad 36, and the control window 32 moves along with the cursor 38 so as to keep the cursor 38 staying in the control window 32. Preferably, a relative position between the cursor 38 and the control window 32 is consistent. When the object 34 leaves the touchpad 36, the last coordinate set of the cursor 38 is continuously preserved as long as a duration where the object 34 leaves the touchpad 36 is in excess of a predetermined value. Thereby, the user can make the cursor 38 and the control window 32 on the screen 30 perform long-distance movement by repeatedly changing the relative coordinate set on the touchpad 36. The purpose of the control window 32 is to assist positioning the cursor 38 on the screen 30 and so it is not necessary to always display the control window 32 on the screen 30. In fact, it is totally competent even if the control window 32 is not displayed all along.

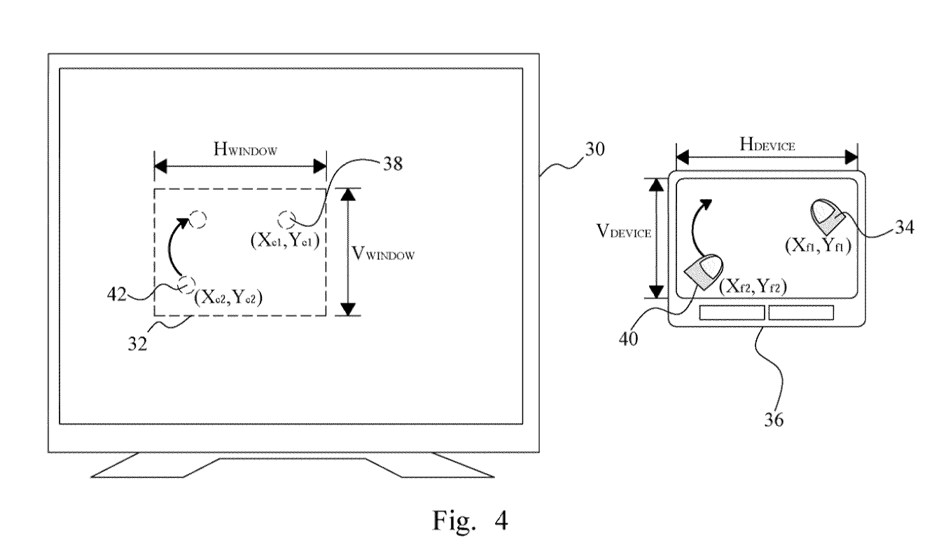

FIG. 4 illustrates step S20 shown in FIG. 1. When a user perform multi-touch operation on the touchpad 36, in addition to the cursor 38 representative the object 34 as shown in FIG. 2, an inter-window coordinate set of a cursor 42 representative of another object 40 in the control window 32 is calculated according to the absolute coordinate set (X_{f2},Y_{f2}) of the object 40 on the touchpad 36 and a resolution ratio

$$\frac{{H}_{WINDOW}}{{H}_{DEVICE}}$$

between the touchpad 36 and the control window 32 as

$${X}_{c 2} = \frac{{H}_{WINDOW}}{{H}_{DEVICE}} \times {X}_{f 2} , {Y}_{c 2} = \frac{{V}_{WINDOW}}{{V}_{DEVICE}} \times {Y}_{f 2} . \qquad [ Eq \text{-} 2 ]$$

When the object 34 or 40 slides on the touchpad 36, the control window 32 remains still while the cursors 38 and 42 according to the absolute coordinate sets of the objects 34 and 40 on the touchpad 36, respectively, have their inter-window coordinate sets (X_{c1},Y_{c1}) and (X_{c2},Y_{c2}) in the control window 32 changed. In other words, the cursors 38 and 42 have their positions with respective to the control window 32 changed. For example, movement of the object 40 on the touchpad 36 consequently changes the inter-window coordinate set (X_{c2},Y_{c2}) of the cursor 42 in the control window 32. The user can simply realize multi-finger operation that supports the multi-touch environment screen 30 such as scaling up, scaling down and rotating by using one or more fingers of either of his/her hands to intuitively operate on the touchpad 36, just like using his/her fingers to directly operate on the screen 30. The screen 30 may or may not display the cursors 38 and 42, so that the user may not see the cursors 38 and 42 moving on screen 30 while their coordinate sets on the screen 30 are exactly changed.

In other embodiments, there is a counter counts time when the object 32 or 40 leaves the touchpad 36. If the leaving duration is in excess of a predetermined value, the cursor 38 or 42 representative of the leaving object is hidden from the screen 30, and all information of the cursor including the inter-window coordinate set (X_{c1},Y_{c1}) or (X_{c2},Y_{c2}) is deleted. Before the leaving duration is in excess of a predetermined value, all information of the cursor 38 or 42 representative of the leaving object including the inter-window coordinate set (X_{c1},Y_{c1}) or (X_{c2},Y_{c2}) is preserved. In another embodiment, before the object 32 or 40 leaves the touchpad 36 for the duration in excess of the predetermined value, only the inter-window coordinate set (X_{c1},Y_{c1}) or (X_{c2},Y_{c2}) of the cursor 38 or 42 representative of the leaving object is preserved.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims

What is claimed is:

1. A method for operation to a multi-touch environment screen by using a touchpad, the method comprising the steps of:
(a) defining a movable control window on the screen;
(b) when the touchpad is detected being touched, calculating an inter-window coordinate set of the detected object mapped from the touchpad to the control window according to an absolute coordinate set of the object on the touchpad and a resolution ratio between the touchpad and the control window;
(c) defining a cursor representative of the object on the screen according to the inter-window coordinate set; and
(d) according to a number and movement of the object on the touchpad, changing a coordinate set of the cursor representative of the object on the screen or the inter-window coordinate set of the cursor representative of the object in the control window.

2. The method of claim 1, wherein the control window has a variable resolution.

3. The method of claim 1, wherein the control window has a maximum resolution equal to that of the screen.

4. The method of claim 1, further comprising displaying the control window on the screen.

5. The method of claim 1, wherein the step (c) comprises the step of locating the cursor representative of the object on a site represented by the inter-window coordinate set.

6. The method of claim 1, wherein the step (c) comprises the step of defining the cursor which has been in the control window as the cursor representative of the object.

7. The method of claim 6, further comprising the step of updating the inter-window coordinate set by using the cursor representative of the object.

8. The method of claim 6, further comprising the step of adjusting a coordinate set of the control window on the screen by using the coordinate set of the cursor representative of the object on the screen as a basis.

9. The method of claim 1, wherein the step (d) comprises the step of, when the number of the object is equal to one, displaying the cursor representative of the object on the screen, and changing the coordinate set of the cursor representative of the object on the screen according to a relative movement coordinate set of the object on the touchpad.

10. The method of claim 9, further comprising the step of controlling the control window to move along with the cursor representative of the object so as to keep the cursor representative of the object staying in the control window.

11. The method of claim 10, wherein a relative position between the cursor representative of the object and the control window is consistent.

12. The method of claim 1, wherein the step (d) comprises the step of, when the number of the object is greater than one, fixing a coordinate set of the control window on the screen, and changing the inter-window coordinate set of the cursor in the control window representative of the object according to the absolute coordinate set of the object on the touchpad.

13. The method of claim 1, further comprising the step of displaying the cursor representative of the object on the screen.

14. The method of claim 13, further comprising the step of, when the object leaves the touchpad for a duration in excess of a predetermined value, hiding the cursor representative of the object from the screen.

15. The method of claim 1, further comprising the step of, when the object leaves the touchpad for a duration in excess of a predetermined value, deleting all information about the cursor representative of the object, including the inter-window coordinate set.

16. The method of claim 1, further comprising the step of, when the object leaves the touchpad for a duration not in excess of a predetermined value, preserving the inter-window coordinate set of the cursor representative of the object.

17. The method of claim 1, further comprising the step of, when the object leaves the touchpad for a duration not in excess of a predetermined value, preserving all information about the cursor representative of the object, including the inter-window coordinate set.
